(19) United States
(12) Patent Application Publication
(10) Pub. No.: US 2004/0199411 A1
(43) Pub. Date: Oct. 7, 2004

(54) Method and system for rebooking a passenger

(76) Inventors: Jeffrey Mark Bertram, Peachtree City, GA (US); Albert Edward Houck III, Tyrone, GA (US)

Correspondence Address: Robert T. Neufeld, Esq., KING & SPALDING, LLP, 45th Floor, 191 Peachtree Street, N.E., Atlanta, GA, 30303, US

(21) Appl. No.: 10/406,960

(22) Filed: Apr. 4, 2003

(51) Int. Cl. G06F 17/60

(52) U.S. Cl. 705/5; 705/1

(57) ABSTRACT

A computer-implemented system for changing the travel reservation of a passenger based on the detection of a modification event. The system employs a voyage monitoring software module that can be used to monitor passengers and anticipate needed changes in reservations. Once a passenger's reservation is rebooked, a local computer system and a local graphical information display system can be used to display the updated travel reservation and permit boarding under the new reservation. The entire system facilitates the movement of passengers through terminals to their respective departure points. The system also reduces the number of personnel needed to manage irregular travel operations and eliminates the need to create new physical documents for each reservation that is changed.

### RELATED APPLICATIONS

This patent application is related to U.S. patent application Ser. No. 09/724,290, filed Nov. 28, 2000, entitled “Method and System for Remote Check-In with a Carrier”; U.S. patent application Ser. No. 09/968,738, filed Sep. 28, 2001, entitled “System and Method for Boarding Passengers onto Multiple Vehicles”; and U.S. patent application Ser. No. 09/708,890, filed Nov. 8, 2000, entitled “Method and System for Providing Dynamic and Real-Time Air Travel Information.” All of these related applications are assigned to Delta Air Lines, Inc. and the complete disclosure of each related application is incorporated herein by reference.

### TECHNICAL FIELD

The present invention is generally directed to managing the boarding of passengers onto transportation vehicles. More specifically, the present invention provides a system and method that support the rebooking of passengers from one voyage to another.

### BACKGROUND OF THE INVENTION

Airplane travel is becoming an increasingly popular means of travel for people today. This popularity has caused the number of airplane flights to increase and a greater volume of travelers to pass through today's airports. The increased number of travelers also causes more congestion and longer lines at the airports. Accordingly, airlines need more efficient ways to handle their passengers.

Airlines generally require passengers to check-in upon arriving at the airport for their flight. The check-in process can serve several functions. It confirms for the airline that a passenger with a reservation is in fact going to travel on the flight. The airline can also verify the passenger's identity, which assists in eliminating fraud and security threats, and to fulfill requirements for securing baggage. For the passenger, the check-in process is a means to verify her itinerary, check baggage, and, if not already done, receive a seat assignment. At the completion of the check-in process the passenger is given a traditional boarding card for the particular flight that will permit her to board the airplane. A separate boarding card is typically issued for each segment of a flight itinerary.

Often times, a passenger is required to change her travel plans. A passenger's travel plans may change for a variety of reasons, including inclement weather, carrier equipment problems, and changes in the passenger's personal schedule. Passengers often need to change their travel plans either at the airport or when they are on their way to the airport. Changing a passenger's travel plans generally requires rebooking the passenger on an alternate flight. The rebooking process can be a significant expenditure of time and resources for the carrier and a source of delay and frustration for the passenger. The rebooking process is also complicated because it is a function of seat availability on other flights and the passenger often has to proceed to a different departure gate at the airport.

The problems associated with rebooking are particularly acute for connecting passengers. Connecting passengers are those passengers on an inbound flight that have a reservation on another flight that is scheduled to depart shortly after the inbound flight is supposed to arrive. Various delays associated with air travel can cause connecting passengers to miss their connections. When connecting passengers miss their connections, this causes a significant added burden for the carrier. First, the carrier must locate availability on a later flight for the passenger. Second, the carrier may incur an opportunity cost if it is unable to resell the seat originally reserved for the connecting passenger. Third, the manual process of rebooking connecting passengers and assisting passengers whose travel plans change has a significant associated cost in the human resources of the carrier. Finally, the rebooking process can delay the checking-in and boarding processes of other flights.

Accordingly, there is a need for a more efficient means for rebooking passengers when their travel plans change. Specifically, there is a need for a carrier to be able to anticipate those passengers that need to change their travel plans and to easily rebook those passengers on the next available flight. Once the rebooking is accomplished, there is a need to deliver the rebooking information expediently to the affected passengers so that they can proceed directly to the appropriate departure gate. Finally, there is a need to allow the passenger to board the rebooked voyage without generating additional paperwork and without requiring additional assistance from carrier personnel.

### SUMMARY OF THE INVENTION

The present invention is generally directed to a distributed computing system that supports the rebooking and boarding of passengers at a transportation terminal. The present invention improves upon existing approaches to managing changes in passenger travel plans by using an information display system, in combination with other carrier systems, to assist travelers with changing travel plans. Using these various systems, a carrier can anticipate and effectuate rebooking of passengers whose travel plans have changed. Once passengers have been rebooked, the carrier can use the information display system to provide passengers with their rebooking information immediately upon arrival at the terminal. The information display system presents travel-related information that allows passengers to proceed to the correct departure gate expeditiously and reduces the demands on carrier personnel needed to assist passengers. Finally, a local computer system at each passenger's departure gate can verify a passenger's identity and allow the passenger to board without requiring the production of new documentation for each rebooked itinerary.

In one aspect, the present invention comprises a method for managing changes in a passenger's travel itinerary. A carrier agent can utilize a flight monitoring software module to identify a passenger requiring rebooking. The rebooking may be necessitated because of changed flight schedules, delays caused by inclement weather or equipment problems, or changes in a passenger's personal schedule. Using the flight monitoring software, the agent can rebook the passenger on the next available flight, as well as placing the passenger on standby for any earlier flights. When the passenger arrives at the terminal, the information display system can provide the passenger with the new rebooking information so that the passenger can proceed directly to the correct departure gate. Upon arriving at the departure gate, the passenger can obtain information from the information display system to confirm that she is at the correct gate for the rebooked flight. Lastly, the passenger can use her original documentation or a piece of identification to board the flight without having new documents printed to reflect the rebooking information. The local computing system at the departure gate can receive the passenger's rebooking information and confirm that the passenger is permitted to board upon receiving identifying data from the passenger.

In another aspect, the present invention comprises a method for changing the travel itinerary of a connecting passenger that will be unable to make a connecting flight. A flight monitoring software module can monitor passengers on inbound flights and identify those passengers that will be delayed and unable to make it to connecting flights. Upon identifying such a passenger, the flight monitoring software module can rebook the passenger on the next available flight after her projected arrival. Once the passenger is rebooked, the information display system can deliver the new itinerary information to the passenger. Delivery methods can include displaying the information on an electronic display and transmitting the information to the passenger's personal digital device. The new itinerary information can also be delivered to the local computing system at the passenger's new departure gate. Upon receiving the new itinerary, the passenger can proceed directly to the correct departure gate without requiring new documents to reflect the rebooking information. When the passenger arrives at the new departure gate and boarding begins, the passenger can present identifying information to the local computing system. The local computing system can verify that the passenger is permitted to board using the new itinerary.

In yet another aspect, the present invention comprises a computer-implemented system for supporting the rebooking and boarding of passengers. The invention comprises a data storage device with the carrier's passenger records and a flight monitoring software module that assists in tracking the passengers. When a passenger requires a change in her travel itinerary, the flight monitoring software can identify the next available flight and rebook the passenger accordingly. The rebooking information is delivered to the passenger using an information display system so that, when the passenger arrives at the airport, she can go directly to the correct departure gate without receiving new boarding documents. A local computing system at the departure gate also receives the rebooking information and verifies that the passenger is permitted to board.

These and other aspects of the invention will be described below in connection with the drawing set and the appended specification and claim set.

### BRIEF DESCRIPTION OF THE DRAWINGS

FIG. 1 is a functional block diagram illustrating the architecture of a distributed computing network in accordance with an exemplary embodiment of the present invention.

FIG. 2 is a logic flow diagram illustrating a process for rebooking a passenger in accordance with an exemplary embodiment of the present invention.

FIG. 3 is a logic flow diagram illustrating a process for identifying a passenger that will miss a connection in accordance with an exemplary embodiment of the present invention.

FIG. 4 is a logic flow diagram illustrating an exemplary process for rebooking a passenger using one embodiment of the present invention.

FIG. 5 is a logic flow diagram illustrating an exemplary process for delivering rebooking information to a passenger using one embodiment of the present invention.

FIG. 6 is a logic flow diagram illustrating an exemplary process for permitting a rebooked passenger to board using one embodiment of the present invention.

FIG. 7A illustrates an exemplary display screen according to one embodiment of the present invention where several instances of the flight monitoring software are shown.

FIG. 7B illustrates an exemplary display screen according to one embodiment of the present invention where one instance of the flight monitoring software is expanded to show additional passenger and flight information.

FIG. 8 illustrates an exemplary display screen according to one embodiment of the present invention showing a screen for delivering standby passenger information.

FIG. 9 illustrates an exemplary display screen according to one embodiment of the present invention showing a screen for delivering cleared standby passenger information.

FIG. 10 illustrates an exemplary display screen according to one embodiment of the present invention showing a screen for delivering rebooking information at a departure gate.

FIG. 11 illustrates an exemplary display screen according to one embodiment of the present invention showing a screen for delivering rebooking information.

### DETAILED DESCRIPTION OF THE EXEMPLARY EMBODIMENTS

The present invention provides a method and system that supports the rebooking of passengers. Specifically, one exemplary embodiment anticipates required changes to passenger travel itineraries and efficiently effectuates the rebooking. Another exemplary embodiment supports expedited delivery of the passenger's new itinerary to the passenger. The new itinerary can be delivered to the passenger through the use of electronic displays located in a terminal and at arrival and departure gates. Alternatively, the new itinerary can be delivered to the passenger's telephone or personal digital device. Delivering rebooking information to the passenger immediately upon arrival at the terminal allows the passenger to proceed directly to the correct departure gate and reduces the amount of customer support that needs to be provided by carrier agents. A further exemplary embodiment supports the delivery of the passenger's new booking information to a local computer system at the departure gate. Supplying the local computer system with the passenger's updated travel information allows the passenger to board with a previously issued boarding pass or other piece of identification. Eliminating the need to create new boarding documents for the passenger streamlines the rebooking and boarding processes.

A representative embodiment of the present invention is described herein in the context of a commercial air carrier. It should be understood that air transportation is only one exemplary embodiment of the invention concept and that additional embodiments of the invention can be used to support other modes of transportation, such as by train, bus, or ship. The invention also has applications beyond the transportation industry where tracking of large volumes of people is performed. For example, the invention could be implemented to manage the passage of people through a common area to multiple destinations, including in an amusement park and a multiplex theater.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations in a distributed computing environment by conventional computer components, including remote file servers, remote computer servers, processing units, local computer systems, local or remote memory storage devices, display devices and input devices. Each of these conventional distributed computing components is accessible by the processing unit via a communications network.

The processes and operations performed by the distributed computing environment include the manipulation of signals by a processing unit or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Referring now to the drawings, in which like numerals represent like elements throughout the several figures, aspects of the present invention and an exemplary operating environment will be described.

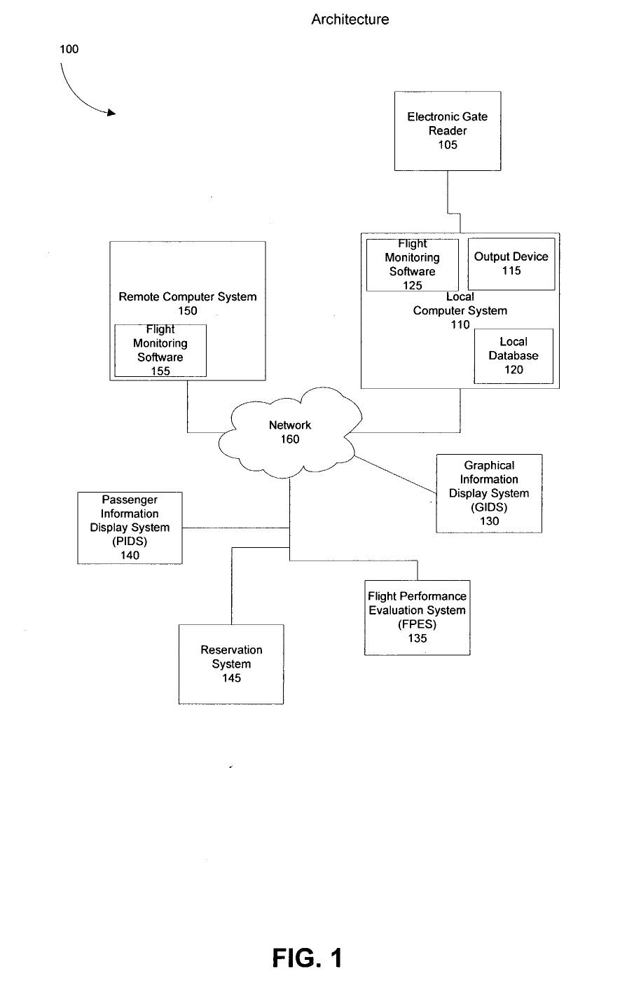

FIG. 1 illustrates various aspects of an exemplary computing environment in which the present invention is designed to operate. Those skilled in the art will appreciate that FIG. 1 and the associated discussion are intended to provide a brief, general description of the preferred computer hardware and program modules, and that additional information is readily available in the appropriate programming manuals, user's guides, and similar publications.

FIG. 1 illustrates the architecture 100 for supporting the operation of an exemplary embodiment of the present invention for performing a rebooking process. As shown in FIG. 1, a flight monitoring software module 155 operates on a remote computer system 150. The remote computer system 150 is typically located in the carrier's back office and is remote from the activities of the terminal. A carrier agent using the flight monitoring software 155 operating on the remote computer system 150 can monitor a passenger on a particular flight to determine whether the passenger will arrive at the airport with adequate time to make a connecting flight. If it does not appear that the passenger will be able to make the connecting flight, the carrier's agent can revise the passenger's itinerary so that the passenger will have a reservation on the next available flight that accommodates the passenger's arrival time. It should be obvious to one skilled in the art that the process of identifying a passenger unable to make a connection and rescheduling the passenger on a later flight can also be automated so that it can be performed without the assistance of an agent.

Although the exemplary embodiment described in the drawings appended hereto addresses the situation of a passenger on an inbound flight that has a connecting flight, the teachings described herein can also be applied to solve other problems with rebooking of passengers. For example, the carrier's agent can also monitor and revise passenger itineraries that are affected by weather delays, equipment problems, or other changes in flight schedules. In another embodiment, the carrier's agent can be equipped to receive a request from a passenger for revising an itinerary and change the itinerary accordingly.

The remote computer system 150 is coupled to a dynamic database. In the exemplary representation in FIG. 1, the dynamic database 130 comprises a passenger information distribution system (PIDS) 140 and a flight performance evaluation system (FPES) 135. The PIDS 140 contains the carrier's passenger records. The FPES 135 contains the carrier's flight data and can provide connecting flight information to the local computer system 110. The flight monitoring software module 155 is designed such that several separate instances of the software can be operating simultaneously, each instance corresponding to a particular flight. When an instance of the flight monitoring software 155 is opened for a particular flight, the flight monitoring software 155 subscribes to PIDS 140 and FPES 135 and obtains the data related to that flight. As passenger and flight information changes, the dynamic databases 135 and 140 are updated and current data is provided to the flight monitoring software 155.

The local computer system 110 comprises a local database 120 for storing passenger and flight information. The local computer system 110 can also comprise flight monitoring software module 125 and an output device 115 for displaying passenger and flight information to a gate agent. When preparing to board a flight through a particular gate, the local computer system located at that gate can subscribe to the FPES 135 and the PIDS 140 to obtain current information for the departing flight. If a passenger's itinerary has changed and she is now on the departing flight, the current data concerning that passenger is transmitted to the local computer system 110. In receiving the most current passenger data, the local computer system 110 can expediently identify those passengers scheduled to depart on the outbound flight and allow them to board.

An electronic gate reader 105, operable for reading passenger data from a boarding card, is coupled to the local computer system 110. Alternatively, the electronic gate reader 105 can also read other media comprising passenger and flight information. Examples of ways in which the electronic gate reader 105 operates include scanning a bar code or reading a magnetic strip on a passenger's boarding card. Passenger information is transmitted by the electronic gate reader to the local computer system where it is determined whether a passenger is authorized to board an aircraft.

The graphical information display system (GIDS) 130 coupled to the network 160 allows the carrier to provide current, passenger-specific itinerary updates to passengers as they arrive at the airport. The GIDS 130 comprises electronic display screens that can display passenger and flight information. The electronic display screens of the GIDS 130 are typically located proximate to boarding and arrival gates. The electronic display screens can also be located onboard aircraft, at hotels, and at designated waiting areas. In alternative embodiments of the invention, transmitters can be used in conjunction with or in place of the GIDS system. The transmitters can send itinerary updates to passenger telephones, PDAs, or other types of communication or computing devices upon their arrival at the airport. The prompt delivery of updated itineraries allows passengers to proceed immediately to the correct gate upon arriving at the terminal without needing the assistance of carrier personnel. Further details of an exemplary embodiment of a GIDS system are described in U.S. patent application Ser. No. 09/708,890 entitled “Method and System for Providing Dynamic and Real-Time Air Travel Information” and incorporated herein by reference.

In the exemplary architecture 100, the carrier also employs a reservation system 145 coupled to the network 160. The reservation system 145 manages and stores data related to passenger reservations. Although FIG. 1 shows only one remote computer system 150 and one local computer system 110 coupled to the network 160, it should be understood that the preferred embodiment of the invention operates with multiple local computer systems and remote computer systems. The local computer system 110 is typically proximate to a boarding gate, however, a single local computer system 110 can support multiple boarding gates. Furthermore, a carrier agent can manage the boarding process through one or more gates from a “back office” location using the local computer system.

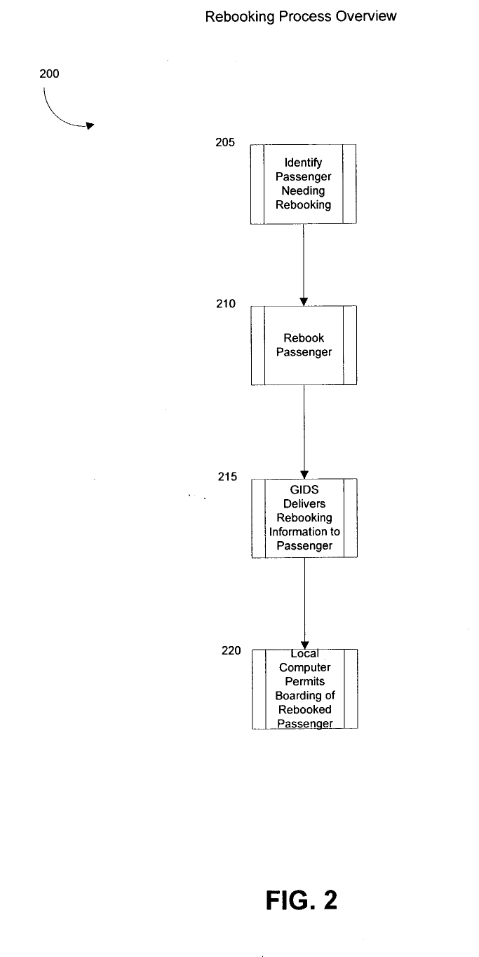

FIG. 2 illustrates an exemplary process 200 for performing a rebooking process in accordance with the present invention. FIG. 2 is a high-level illustration of the process and the subsequent figures will describe the steps of the process 200 in greater detail. Beginning with step 205, a passenger requiring a rebooking is identified. The identification step can be performed by a carrier agent using a flight monitoring software module 155. Alternatively, the flight monitoring software module 155 can automatically identify a passenger requiring a rebooking. Once the passenger requiring a change in her itinerary is identified, in step 210 the passenger's itinerary is rebooked. As with the identification step, the rebooking process can be performed by a carrier agent or, alternatively, it can be performed automatically by the flight monitoring software module 155. The identification and rebooking steps 205 and 210 can be utilized when there has been a change in the carrier's flight schedule or unanticipated delays due to weather or equipment problems. Alternatively, the identification and rebooking can be initiated by the passenger themselves upon a change in their personal schedule that requires a change in their travel itinerary.

In step 215, the GIDS 130 will receive the passenger's rebooking information from the carrier's computer system and convey that information to the passenger. The graphical information display system 130 can receive the rebooking information from the general reservation system 145 or from a specific source of passenger information such as the PIDS 140. The graphical information display system 130 provides the new rebooking information to the passenger via a system of electronic display screens. The electronic display screens can be located at departure gates and other convenient locations throughout the terminal. The electronic screens on which a particular passenger's rebooking information is displayed can be strategically selected so that the passenger is more likely to receive the information. For example, if the passenger is arriving on a flight that has been delayed, the updated rebooking information can be displayed on GIDS displays proximate to the passenger's arrival gate. Alternatively, if the passenger is a member of a frequent flyer program, the rebooking information can be shown on GIDS displays that are proximate to specific frequent flyer waiting areas.

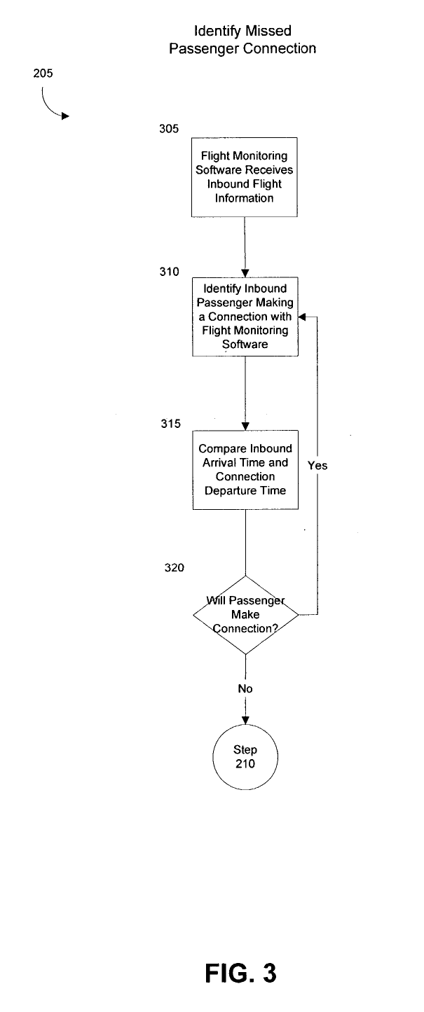

Lastly, in step 220, the local computer system 110 can permit the rebooked passenger to board through the departure point. The local computer system 110 also receives the passenger's rebooking information from the carrier's reservation system 145 or the passenger information display system 140. The local computer system 110 is typically located proximate to the departure point. The electronic gate reader device 105 coupled to the local computer system 110 can receive identifying information from the passenger before boarding in order to verify her identity. Once the local computer system 110 verifies the rebooked passenger's identity, she is free to board. The processes illustrated in FIGS. 3, 4, 5 and 6 will describe the steps of process 200 in greater detail.

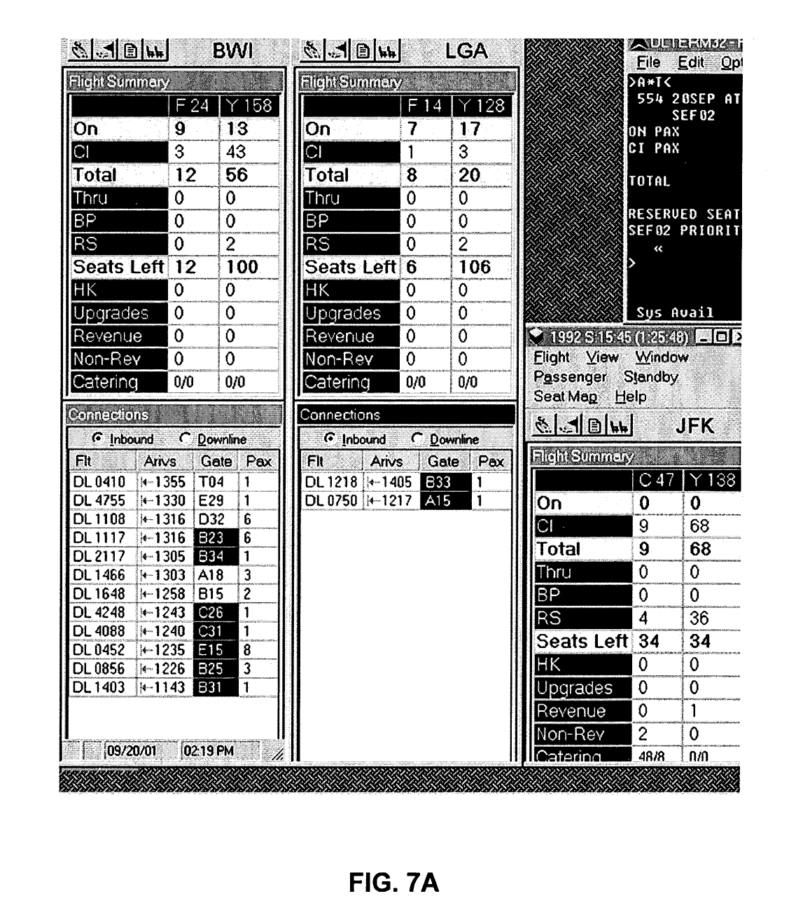

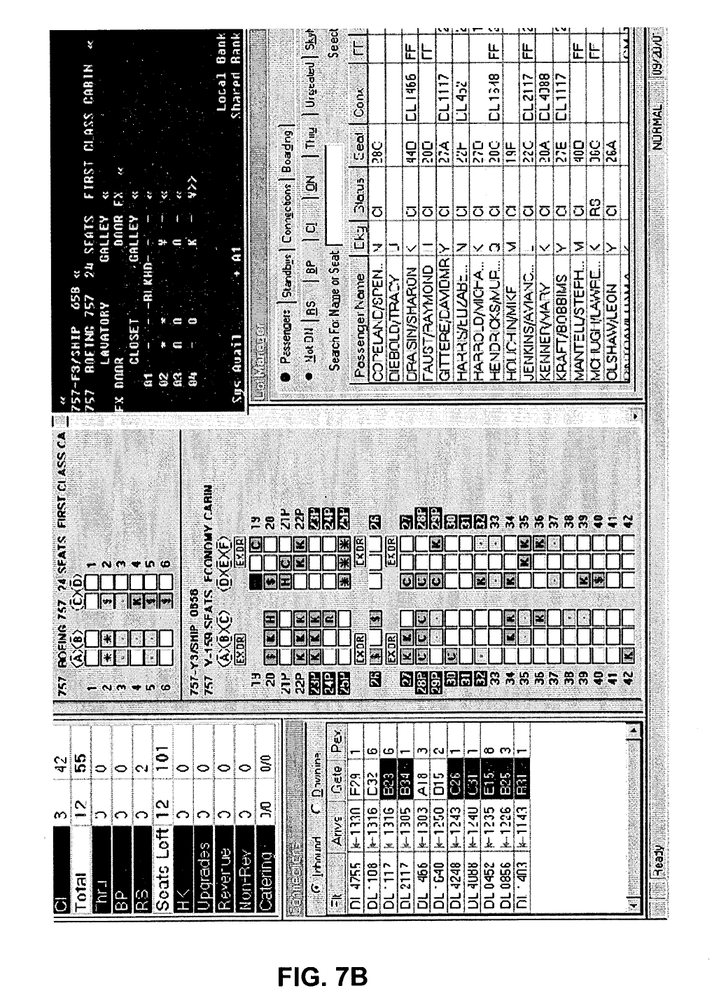

Process 205, illustrated in FIG. 3, shows an exemplary process for identifying a passenger requiring a rebooking. Specifically, process 205 concerns a passenger on an inbound flight that is scheduled to board a connecting flight. Alternative embodiments of the present invention can identify passengers other than those on an inbound flight with connections. In step 305, the flight monitoring software module 155 receives flight information for an inbound flight. The information displayed by the flight monitoring software module can include the passenger's name, the passenger's seat, whether the passenger has baggage, and whether the passenger has a connecting flight. Exemplary display screens illustrating the information displayed by the flight monitoring software module are shown in FIGS. 7A and 7B. In step 310, those passengers on the inbound flight that have a connection are identified by the flight monitoring software module 155. In step 315, the estimated arrival time of the inbound flight can be compared to the estimated departure time of the connecting flight to see whether or not the passenger will be able to make their connecting flight.

Steps 310 and 315 of process 205 can be performed either automatically by the flight monitoring software module 155 or, alternatively, by a carrier agent operating the flight monitoring software module 155. In step 320, if it is determined that the passenger will make their connection, the passenger's booking information will remain the same and another passenger will be examined. Alternatively, if the passenger will not make her connecting flight or is unlikely to make her connecting flight, the rebooking process described in step 210 is performed.

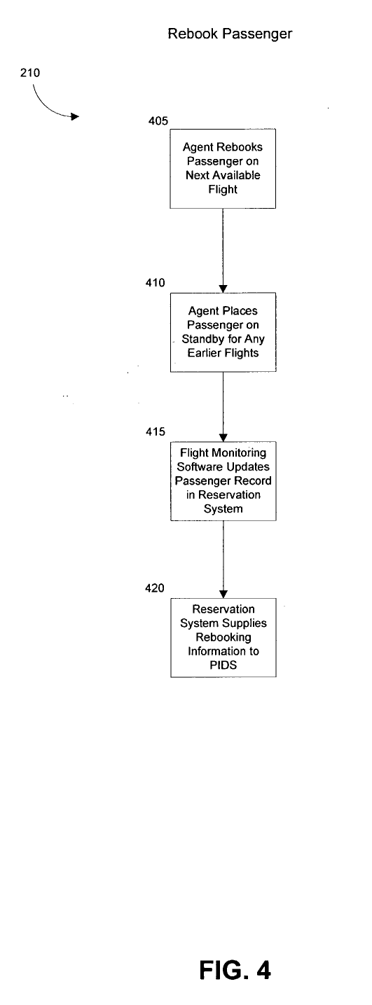

The rebooking process 210 anticipates that a passenger will not be able to make their flight and will require a modification in their travel itinerary. By anticipating the need for a rebooking, the entire rebooking process can be expedited and the carrier can better serve its customers. Alternatively, instead of anticipating needed rebookings, the carrier can also respond more efficiently to unexpected changes in flight schedules or requested changes in itineraries from passengers. Referring to FIG. 4, in step 405, the agent operating the flight monitoring software module 155 can rebook the passenger on the next available flight after they are estimated to arrive. Alternatively, as described above, this process of rebooking can be performed automatically by the flight monitoring software module 155.

In step 410, the agent can also place a passenger on standby for any flights that happen to be earlier than the next available flight. In step 415, the flight monitoring software 155 updates the carrier's reservation records maintained in the reservation system 145 with the passenger's new rebooking information. The new rebooking information can comprise the reservation on a later flight as well as any standby reservations. Finally, in step 420, the reservation system 145 provides the rebooking information to the passenger information display system 140. Once the passenger's rebooking information is stored in the PIDS 140 or the reservation system 145, it can be accessed by the carrier's other systems to effectuate boarding.

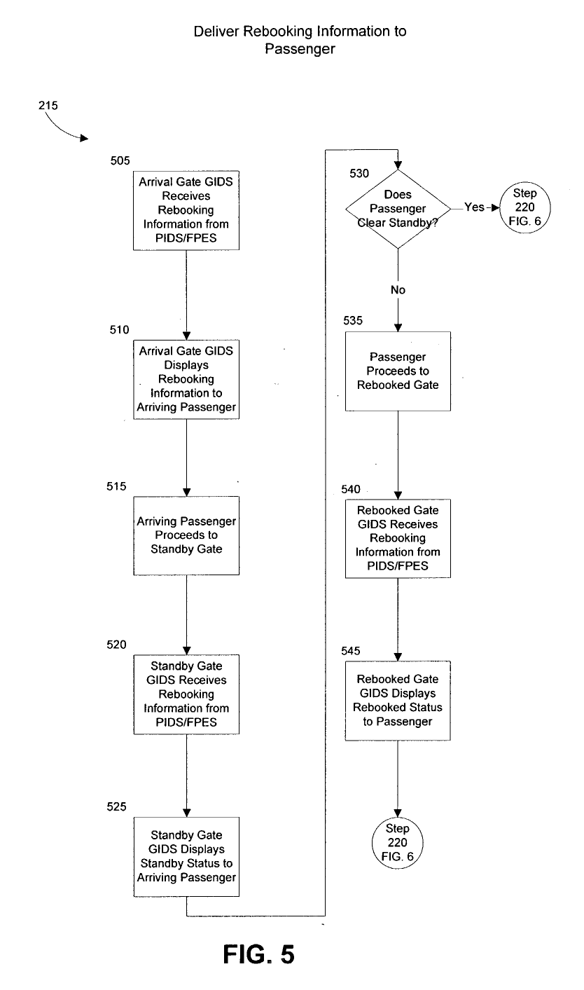

FIG. 5 illustrates an exemplary process 215 for delivering the passenger's new travel information to the passenger upon their arrival at the terminal. By immediately providing the new rebooking information to the passenger, this will streamline the rebooking and boarding process and eliminate many of the passenger's questions. The exemplary process 215 illustrated in FIG. 5 addresses the delivery of information to a passenger on an inbound flight with a connection. Alternative embodiments of the invention can address the delivery of information to passengers arriving at the terminal in other ways. In step 505, the GIDS screen 130 at the arrival gate receives the rebooking information from the passenger information display system 140. Exemplary rebooking information displayed on the GIDs screen can include the passenger's reservation on a later flight, the gate for the flight, and any possible standby information. The rebooking information can also be delivered to other GIDS screens proximate to the passenger's arrival gate. The GIDS 130 located at an arrival gate typically has several different screens of information that can be displayed to passengers. One of these screens can address information directed to passengers deboarding from a flight that has just arrived.

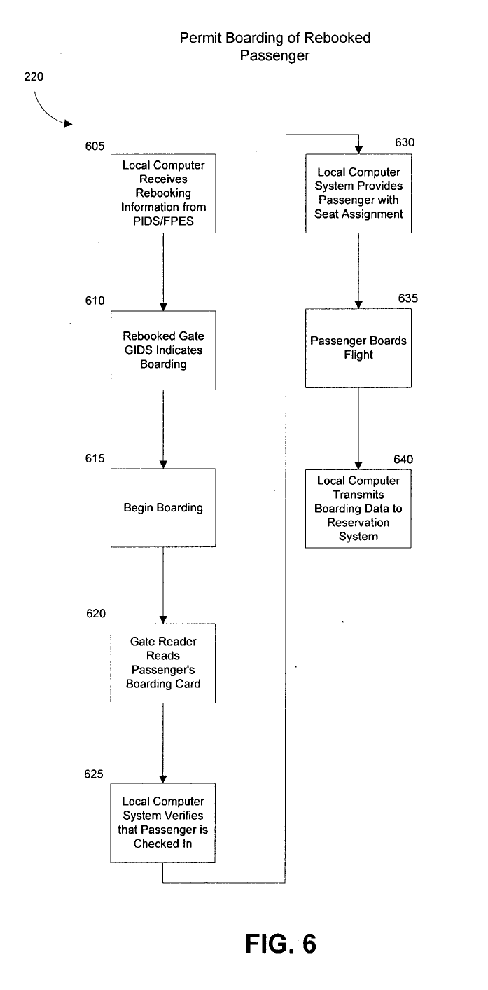

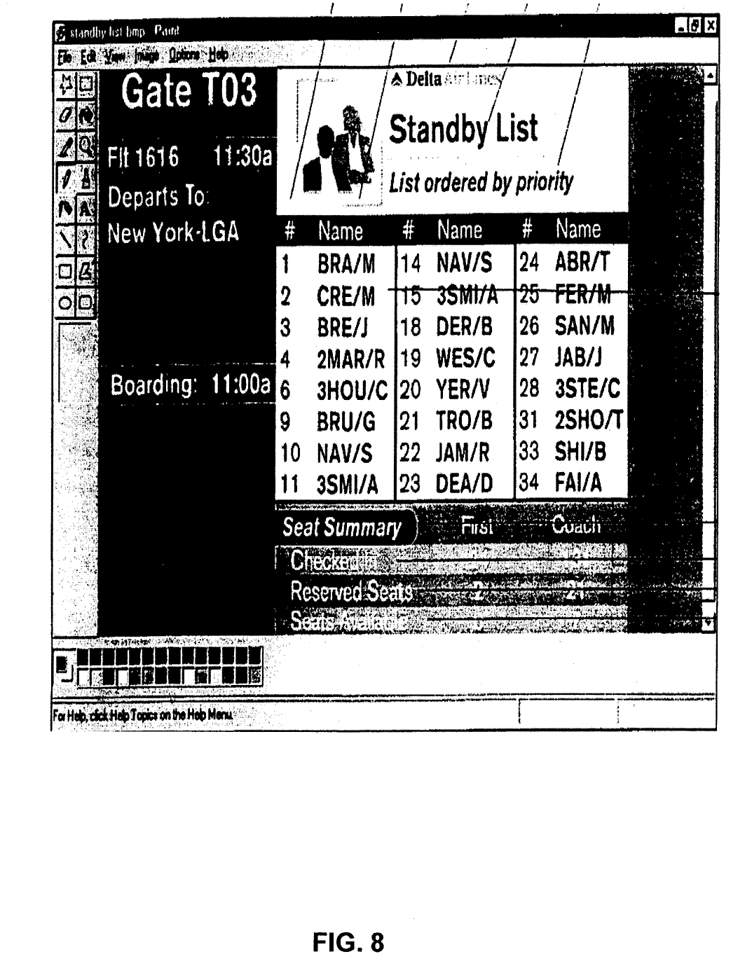

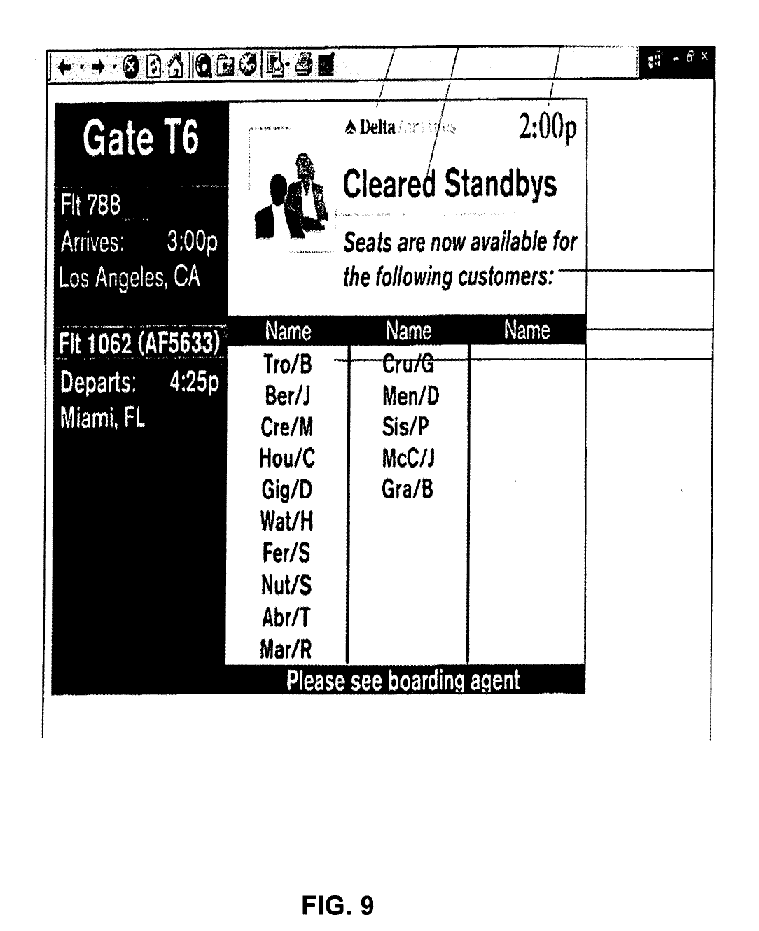

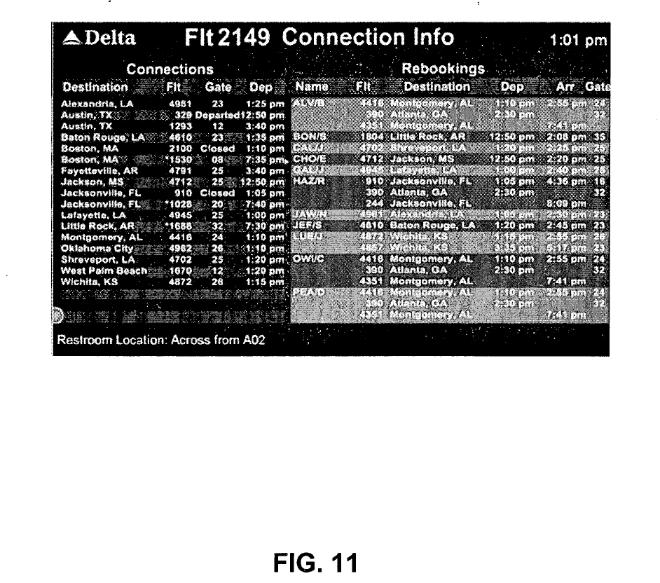

In step 510, the GIDS 130 at the arrival gate, and possibly other nearby GIDS screens, display the rebooking information to the arriving passenger as she deboards the plane and passes through the arrival gate. A representative GIDS screen displaying rebooking information to passengers is illustrated in FIG. 11. The arriving passenger that has been delayed and missed her connection will read the rebooking information from the GIDS display screen and can then proceed to the correct standby gate in step 515. Alternatively, if the passenger was not placed on a flight on standby status, she can proceed directly to the flight for which she has been rebooked. In step 520, the GIDS 130 located at the standby gate will also receive the rebooking information from the PIDS 140. By displaying this information at the departure gate for the flight for which the passenger is on standby status, this will reconfirm for the passenger their status and let them know that they have proceeded to the correct gate. An exemplary screen display showing standby information is illustrated in FIG. 8. FIG. 8 shows that the information on the standby screen comprises the flight, the departure gate, seat availability the passenger's name (using the first three letters of the last name and the first initial), and the passenger's priority rank. If the passenger clears standby status in step 530, she will be permitted to board and can proceed to the boarding process illustrated in FIG. 6. An exemplary screen display showing passengers that have cleared standby status is illustrated in FIG. 9.

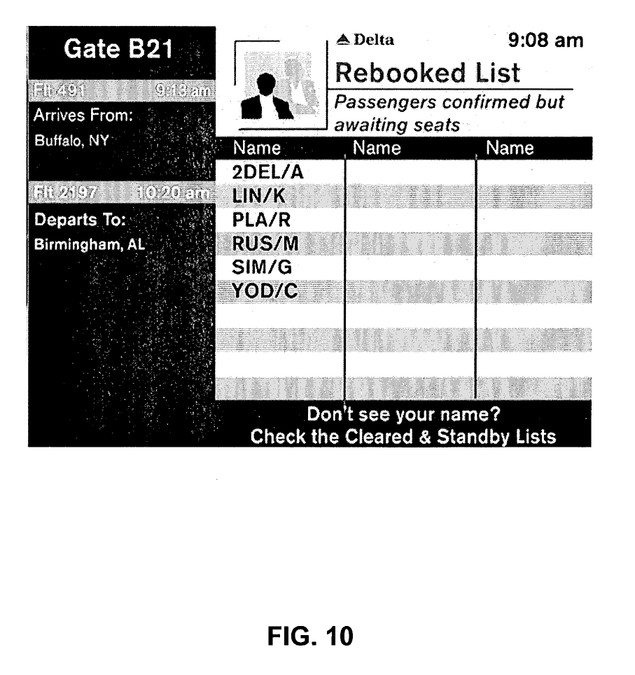

Alternatively, if the passenger is unable to clear standby status, they can proceed to the gate for which they are rebooked on a flight in step 535. The GIDS 130 located at the rebooked gate will receive the rebooking information from PIDs 140 as well. The GIDS system located at the rebooked gate will display this information to the passenger so that she knows it is the correct gate for the new flight. A representative screen display located at the rebooked gate showing rebooking information is illustrated in FIG. 10.

The final step of the rebooking process concerns the process 220 for boarding a passenger that has been rebooked. In contrast to conventional rebooking systems where passengers are required to receive new documentation reflecting the change in their itinerary, the present invention supports boarding of the passenger without the creation of new documents. In step 605 of FIG. 6, the local computer system 110 at the passenger's departure gate also receives the passenger's new rebooking information from the passenger information display system 140. The GIDS 130 located at the departure gate will have already received and displayed the passenger's rebooking information to assist the passenger in identifying the correct departure gate. When boarding begins, the GIDS 130 will display the passenger's name as one of those scheduled to board on the departing flight.

In step 615, upon being prompted by the GIDS 130 in step 210, the passengers will begin to board the flight through the departure gate. When the rebooked passenger reaches the departure gate, she can present her identifying information to the local computer system 110. The rebooked passenger's identity can be ascertained from a variety of different pieces of information. The passenger may be able to use her original boarding card, a permanent identity card issued by the carrier, a driver's license, or a passport. Alternatively, the local computer system 110 may use other biometric methods of ascertaining the passenger's identity.

Upon receiving the passenger's identifying information, in step 625, the local computer system will verify that the passenger is checked in for the flight that is scheduled to depart. The local computer system 110 will check the rebooked passenger's identity against the rebooking information it previously received from the PIDs 140. In step 630, after the local computer system has verified that the passenger may board, the passenger seat assignment can be displayed. Alternatively, the local computer system 110 may print out a hard copy of the passenger's seat or, may simply direct the passenger to board without a particular seat assignment. In step 635, the passenger then proceeds through the boarding gate and boards the flight. The local computer system 110 will then transmit the fact that the passenger has boarded to the reservation system 145. The fact that the passenger has boarded will be used to update the carrier's records.

In conclusion, the present invention, as represented in the foregoing exemplary embodiments, enables a carrier to simply and expedite the rebooking of passengers. This process is particularly useful for rebooking connecting passengers on later flights so that they can proceed directly to the correct gate upon arriving at the airport. This process is also helpful for a carrier that has to make numerous rebookings in a short period of time such as when flight schedules are changed because of weather or equipment problems. Quickly identifying and rebooking those passengers that require a change in their itinerary allows the carrier to make efficient use of available seating on all flights. Delivering the rebooking information to the passengers immediately upon arrival also reduces the amount of carrier personnel needed at the terminal and gates to assist passengers. Finally, delivering the rebooking information to the passenger's new departure gate streamlines the boarding process and eliminates the need to produce additional documentation for each rebooked passenger.

It will be appreciated that the present invention fulfills the needs of the prior art described herein and meets the above-stated objects. While there has been shown and described the preferred embodiment of the invention, it will be evident to those skilled in the art that various modifications and changes may be made thereto without departing from the spirit and the scope of the invention as set forth in the appended claims and equivalents thereof. For instance, the present invention could be used by other commercial carriers for rail and boat transportation and to support connections among different modes of air, ground, and water transportation. The invention can also be used in other environments where patrons pass through a single departure point, such as in an amusement park or multiplex theater. Although the present invention has been described as operating in a distributed computing environment, it should be understood that the invention can be applied to other types of computing systems.

What is claimed is:

1. A method for changing the booking of a passenger on an inbound flight from a first connecting flight to a second connecting flight comprising the steps of:
identifying that the passenger on the inbound flight will not arrive in time to board the first connecting flight;
generating rebooking information by rebooking the passenger on the second connecting flight in recognition that the passenger on the inbound flight will not arrive in time to board the first connecting flight;
delivering the rebooking information to the passenger upon arrival of the inbound flight, wherein the rebooking information comprises a passenger identifier and an identifier for the second connecting flight; and
transmitting the rebooking information to the departure gate of the second connecting flight.

2. The method of claim 1, further comprising the step of receiving the rebooking information at a computer proximate to the departure gate of the second connecting flight that controls boarding.

3. The method of claim 1, wherein the rebooking information is displayed proximate to the departure gate of the second connecting flight.

4. The method of claim 1, wherein the rebooking information is delivered to the passenger with an electronic display located at the arrival gate.

5. The method of claim 1, wherein the rebooking information is delivered to the passenger's personal digital device.

6. The method of claim 1, wherein the rebooking information is announced to the passenger at the arrival gate.

7. The method of claim 1, wherein the step of rebooking the passenger on the second connecting flight occurs without interaction with the passenger.

8. The method of claim 1, wherein the rebooking information is displayed proximate to the departure gate of the second connecting flight with a passenger identifier to facilitate efficient boarding.

9. A computer-readable medium comprising computer-executable instructions for performing the steps required in claim 1.

10. A method for managing a change in a passenger's itinerary comprising the steps of:
receiving an instruction to change the passenger's itinerary from a first departure to a second departure;
rebooking the passenger on the second departure and storing the rebooking as rebooking information;
delivering the rebooking information to the passenger upon arrival at a travel terminal without generating new documents to reflect the rebooking information; and
forwarding the rebooking information to a computing system that uses the rebooking information to permit the passenger to board.

11. The method of claim 10, wherein the rebooking information comprises a passenger name and a second departure identifier.

12. The method of claim 10, wherein the rebooking information is delivered to the passenger with an electronic display located in the terminal.

13. The method of claim 10, wherein the rebooking information is delivered to the passenger on the passenger's personal digital device.

14. The method of claim 10, further comprising the step of receiving a passenger identifier from the passenger at the computing system and comparing the passenger identifier to the rebooking information.

15. The method of claim 10, further comprising the step of comparing the passenger's identity and the rebooking information at the computer and, if they correspond, permitting the passenger to board.

16. A computer-readable medium having computer-executable instructions for performing the steps recited in claim 10.

17. A method for managing a change in an itinerary of a passenger comprising the steps of:
identifying a required modification in a passenger's itinerary;
modifying the passenger's itinerary and storing the modified itinerary;
delivering the modified itinerary to the passenger without generating new documents to reflect the modifying; and
permitting the passenger to board with the modified itinerary.

18. The method of claim 17, wherein the step of identifying a required modification is performed automatically by a flight monitoring software module.

19. The method of claim 17, wherein the step of identifying a required modification is performed in response to a changed flight schedule.

20. The method of claim 17, wherein the step of identifying a required modification is in response to a request from a passenger.

21. The method of claim 17, wherein the step of modifying the passenger's itinerary comprises rebooking the passenger on another departure.

22. The method of claim 17, wherein the modified itinerary is delivered to the passenger with an electronic display located in the terminal.

23. The method of claim 17, wherein the modified itinerary is delivered to the passenger on the passenger's personal digital device.

24. The method of claim 17, wherein the step of permitting the passenger to board further comprises transmitting the modified itinerary to a computer system proximate to the passenger's departure gate, wherein the computer system permits the passenger to board with the modified itinerary.

25. A computer-readable medium having computer-executable instructions for performing the steps recited in claim 17.

26. A computer-implemented system for modifying a passenger's itinerary from a first flight to a second flight comprising:
a data storage component operable for storing passenger and flight data;
a first computer system, coupled to the data storage component, operable for monitoring passenger and flight data and modifying a passenger's itinerary from the first flight to the second flight;
an information delivery system, coupled to the data storage component, operable for receiving the passenger's modified itinerary and delivering the modified itinerary to the passenger; and
a second computer system, coupled to the data storage component, wherein the local computer system is proximate to the departure point of the second flight and is operable for receiving the passenger's modified itinerary and permitting the passenger to board the second flight.

27. The system of claim 26, wherein the local computer system is operable for receiving a passenger identifier and comparing it to the modified itinerary.

28. The system of claim 26, wherein the local computer system is operable for comparing a passenger identifier to the modified itinerary and, if they correspond, permitting the passenger to board.

29. The system of claim 26, wherein the information delivery system comprises an electronic display screen for displaying the passenger's modified itinerary.

30. The system of claim 26, wherein the information delivery system comprises an electronic transmitter for sending the passenger's modified itinerary to a personal digital device.

31. The system of claim 26, wherein the remote computer system is operable for automatically identifying a passenger itinerary that is to be modified and creating the modified itinerary.
